(19) United States
(12) Patent Application Publication
(10) Pub. No.: US 2017/0210302 A1
(43) Pub. Date: Jul. 27, 2017

(54) Automobile smartphone extended arm and Dash Cam

(71) Applicant: Phong Le, San Jose, CA (US)

(72) Inventor: Phong Le, San Jose, CA (US)

(21) Appl. No.: 15/008,275

(22) Filed: Jan. 27, 2016

(51) Int. Cl. B60R 11/02

(52) U.S. Cl. CPC B60R 11/0241; B60R 2011/0007

(57) ABSTRACT

An automobile smartphone extender arm and dashboard-cam accessory for ease of positioning with minimum manual adjustment. Hands free use of the smartphone inside an automobile is accommodated through rotatable joint radial detent construction.

### BACKGROUND

Field of the Invention

The present invention generally relates to smartphone accessories and more specifically, the invention relates to automobile smartphone position adjustable extender arm for viewing the smartphone screen and using the smartphone as a car cam from a quickly adjustable car dashboard area viewing angle without obstructing the dashboard or windshield.

Conventional Handheld Accessories

Some automobile dashboard supported smartphone accessories exist for the smartphone inside the automobile, but few offer any flexibility to users trying to avert looking down and away from the road, on order to view the map or other app function below the dash. Moreover, most dashboard anchored mobile accessories are fixed once installed, preventing motorists from adjusting the smartphone position to their particular physical requirements, proclivities in driving encouraging viewing away from the road.

Selfie sticks have become a pervasive tool for users of smartphones. Smartphones have created a need for extensions away from the body to take pictures at a distance without a third party. But self taken portraits are only one function that smartphones offer that can use an extended position away function. There are myriad of smartphone functions and uses which require a 3rd party positioning for a smartphone as one is in an automobile with hands engaging the steering wheel. What is needed is a reverse selfie stick to aid users in an automobile without burdening a driver's hands.

Wrist mounted devices exist to help users control their smartphones remotely by gesture. These are wholly inadequate to quickly reposition the smartphone cam for new video directions. What is needed are ways to quickly position their smartphones for changing views and vantage points.

We all own smartphones and can use video record of events as they happen on the road. With wireless connection and the cloud we can easily transmit our trip to others or even cloud storage. But mounting the phone on the dashboard is problematic as the smartphone is a sleek somewhat dense device and not easily adhered to the contoured dashboard surface. What is needed are ways to quickly place and quickly change the position of the smartphone to keep video records of any drive, short or long.

### SUMMARY

The present invention discloses a system for an extensible and collapsible arm and dashboard-cam accessory for a smartphone having a boon extensible and collapsible arm with an anchoring component at one end and a universal smartphone holder at the distal end. The anchoring component has a pipe clamp style coupling to a rearview mirror windshield stem and a rotatable joint coupler having a radial sawtooth surface detent mating with the collapsible arm anchor component end, the anchoring clamp neck having an coupled spring clamp with an attachable smartphone holder rotatably coupled to the arm distal end and an electrical cord, where the case further comprises a means to manually control the flow of electric power to the smartphone device and said electric power flow control means to permit manual access to said electric power flow control, and movable rotatable joints between the arm distal end and attachable case allows for easy stable positioning and adjustment of the smartphone.

### BRIEF DESCRIPTION OF DRAWINGS

Specific embodiments of the invention will be described in detail with reference to the following figures.

FIG. 1 is an illustration of an smartphone accessory extender arm and dashboard cam according to an embodiment of the present invention.

FIG. 2 is an illustration of a extender arm and dashboard cam assembly in accordance with an embodiment of the invention.

FIG. 3 is a side view of a smartphone extender arm and dashboard cam assembly in accordance with an embodiment of the invention.

FIG. 4 is a detailed illustration of a smartphone extender arm and dashboard cam assembly in accordance with an embodiment of the invention.

FIG. 5 is an illustration of a smartphone two link extender arm and dashboard cam assembly in accordance with an embodiment of the invention.

FIG. 6 is an illustration of a smartphone two link extender arm and dashboard cam with console anchor in accordance with an embodiment of the invention.

FIG. 7 is an illustration of a smartphone telescoping extender arm and dashboard cam with internal arm flexible coil electrical cord in accordance with an embodiment of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTS AND ADVANTAGES

The present invention discloses smartphone automobile arm driver positionable holder embodiments manual positioning of smartphone safe display and but with easy adjustable dashboard cam viewing.

An object of the invention is to provide a smartphone holder and arm for positioning and retaining a smartphone in a manner that provides quick and easy positioning in the automobile interior without displacing other components or consuming valuable automaker space, such as in the dashboard of the vehicle.

Another object of the invention is to provide a holder and arm assembly for a vehicle with an dockable casing and holder for the smartphone, coupled to a foldable armature which can be anchored to the rear view mirror stem or alternate stable edge, position adjustable within the automobile interior.

Yet another object of the invention is to provide a secured smartphone accessible to an occupant of the vehicle so that the occupant can quickly insert or remove the smartphone from the docking armature independently of the arm anchoring assembly.

In another objective, many smartphone apps drain power so use while powered to electric source is an invention requirement.

Another object of the invention is to provide smartphone position adjustment which can be made quickly and safely.

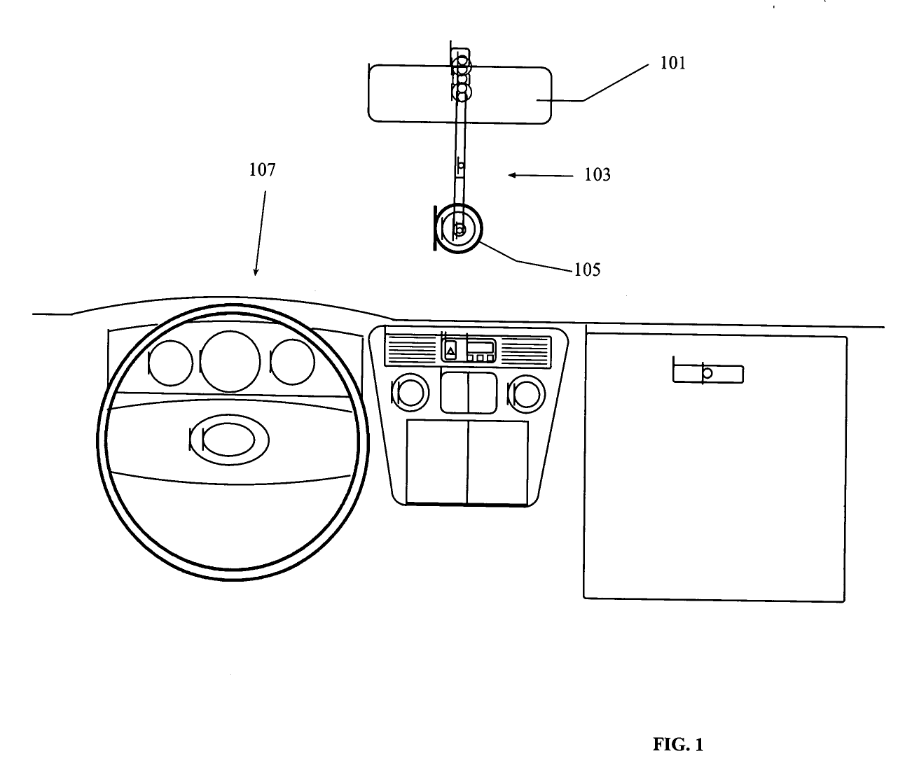

FIG. 1 is an illustration of an smartphone accessory extender arm and dashboard cam according to an embodiment of the present invention. The dashboard 107 houses the various gauges and accessories for the use of the driver, the instrument panel. Using this crowded panel to anchor yet another accessory is problematic, so an aspect of the invention is to anchor off-dashboard as shown in 103, where a smartphone adjustable arm is anchored from a rear view mirror 101 stem, and having a smartphone attaching coupler 105 on the distal end of the arm.

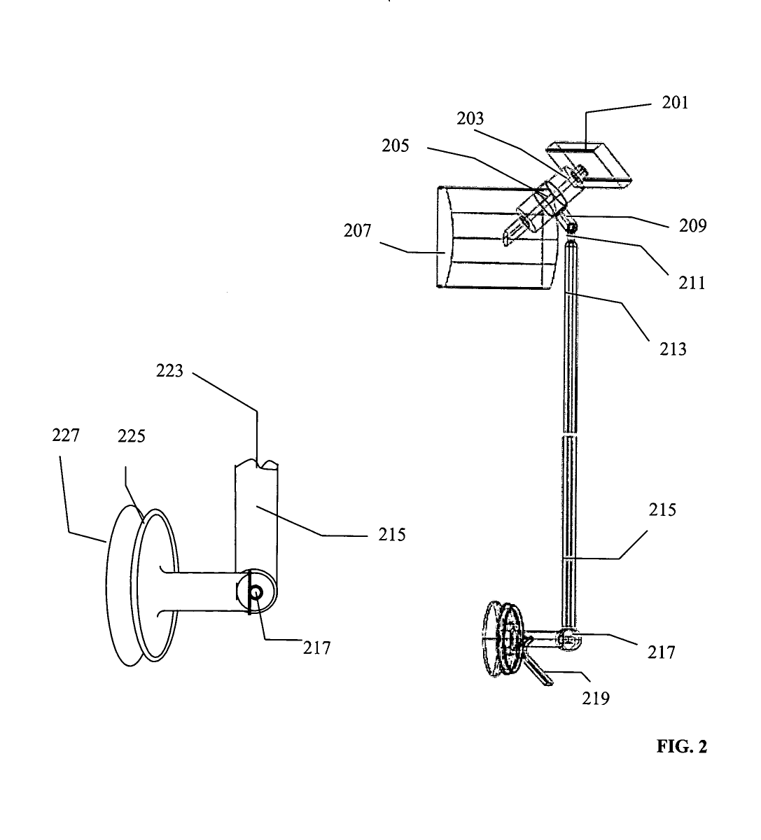

FIG. 2 is an illustration of a smartphone extender arm and dashboard cam assembly in accordance with an embodiment of the invention. A ring clamp 205 secures onto a car windshield 201 rear view mirror 207 stem 203 which provides anchor to an arm 213 stationary base end. The mirror stem 203 ring clamp 205 neck 209 is coupled 211 to the arm 213 via a rotatable hinge 211 for easy adjustment of the smartphone on the arm distal end 215. The arm distal end 215 is coupled to a friction holding hinge with a coupled to a suction connector 227 with a diaphragm 225 and diaphragm flexing handle 219 such that the arm distal end can support a more or less flat surface smartphone. In an embodiment of the invention the arm is hollow tube 223 and can be of clear plastic as well as other plastics, fiber composite, metal or combinations of these materials.

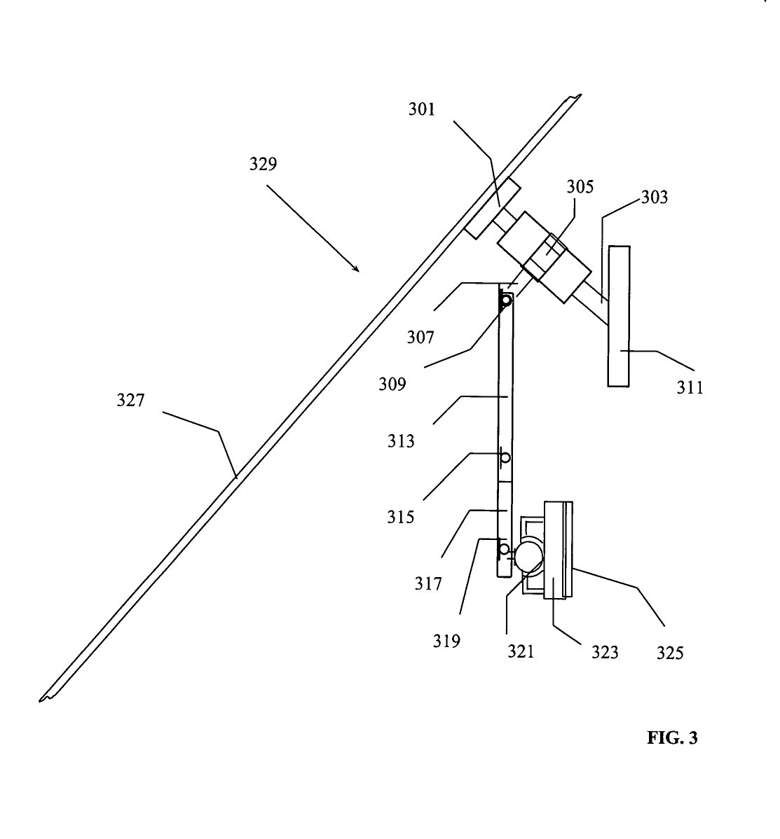

FIG. 3 is a side view of a smartphone extender arm and dashboard cam assembly 329 in accordance with an embodiment of the invention. A vehicle windshield 327 supports a rearview mirror 311 on a stem 303 to a base 301 coupled to the windshield 327. A pipe clamp style collar 305 for coupling with a mirror stem 303 has a neck 307 rigidly connected to a rotational coupler 309 to the arm anchor end 313. The arm 313 distal end 315 is connected to a holder stem 317 coupled 319 ball-and-socket 321 assembly for supporting a smartphone hardcase 323 securing a smartphone 325. The assembly components may be made of plastic, fiber, clear plastic and even light metal tubing

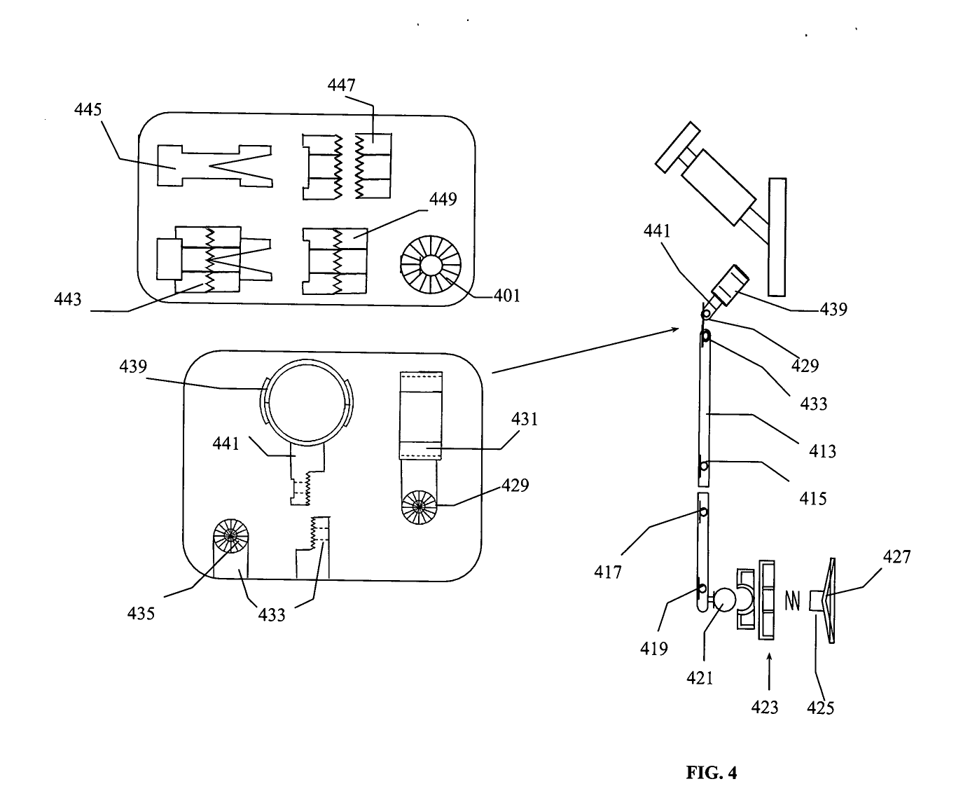

FIG. 4 is a detailed illustration of a smartphone extender arm and dashboard cam hinge coupler assembly and smartphone holder in accordance with an embodiment of the invention.

A collar style pipe clamp 439 431 is shown for securing to an automobile rearview mirror stem, the collar 439 having a neck 441 rigidly connected to a rotational sawtooth ring coupler 429 component is illustrated. The coupler component 429 mates with an arm end complementing detent sawtooth ring coupler 435 component 433 to provide rotational freedom but with friction for manual adjustment to an alternate stationary position. The arm ring coupler component 433 is integrated with the arm anchor end 413. The pipe clamp style coupling to a rearview mirror windshield stem and a rotatable joint coupler having a radial sawtooth surface detent mating 449 with the collapsible arm 413 anchor component end 429 433 allows for easy adjustable placement of the smartphone arm end.

The two ring coupler ring components 429 435 are pin 445 locked with an outside slip ring 443. The arm distal end 415 is coupled to a holder stem end 417 with the second end 419 coupled ball-and-socket 421 assembly for supporting a smartphone hardcase 423 assembly with a diaphragm 427 for providing smartphone back suction adhesion. The assembly components 423 may be made of plastic, fiber, clear plastic, rubber and or light metal tubing

The smartphone holder case assembly is adapted to project light though the opening to provide a light source when the smartphone is docked in the holder. In an embodiment of the invention the case assembly may be of transparent plastic or form to not impede light from the many smartphone light sources. In another smartphone use the smartphone is docked and positioned as a rear view mirror with the smartphone mirror app and flexible arm for easy mirror adjustability.

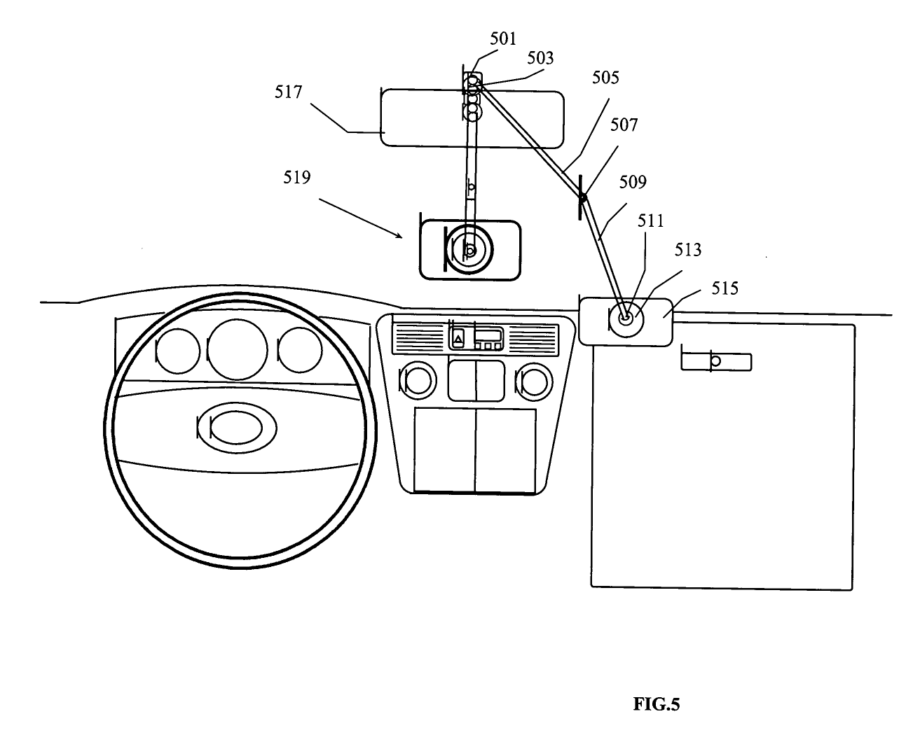

FIG. 5 is an illustration of a smartphone two link extender arm and dashboard cam assembly in accordance with an embodiment of the invention.

An embodiment of the extensible and collapsible arm accessory for a smartphone assemble can have a two linkage arm 505 509 construction, the two hollow tube links 505 509 may have an electrical flexible coil cord accommodating the extension and collapse of the arm. The two link material composition may be substantially of similar material such as plastic, clear plastic, fiber composite metal or other flexible semi-rigid material. These may also be of hollow tube like construction coupled by a rotatable hinge joint.

A ring clamp 501 secures onto a car rear view mirror 517 stem 503 which provides anchor to an arm 505 stationary base end. The mirror stem 503 ring clamp neck is coupled to the first link 505 of a two link arm 509 via a rotatable pipe clamp coupling with an addition clamp neck extension with spring pinch clamp. The two link arm with easy adjustment of the smartphone on the arm distal end 511 and with alternate anchoring placements in the automobile cockpit area. The distal end arm link 511 is coupled to a friction holding joint 507 on one end and to a suction connector 513 with a diaphragm and diaphragm suction application-release handle such that the arm distal end 511 can support a more or less flat surface attachable-detachable smartphone 515 to the suction diaphragm 513.

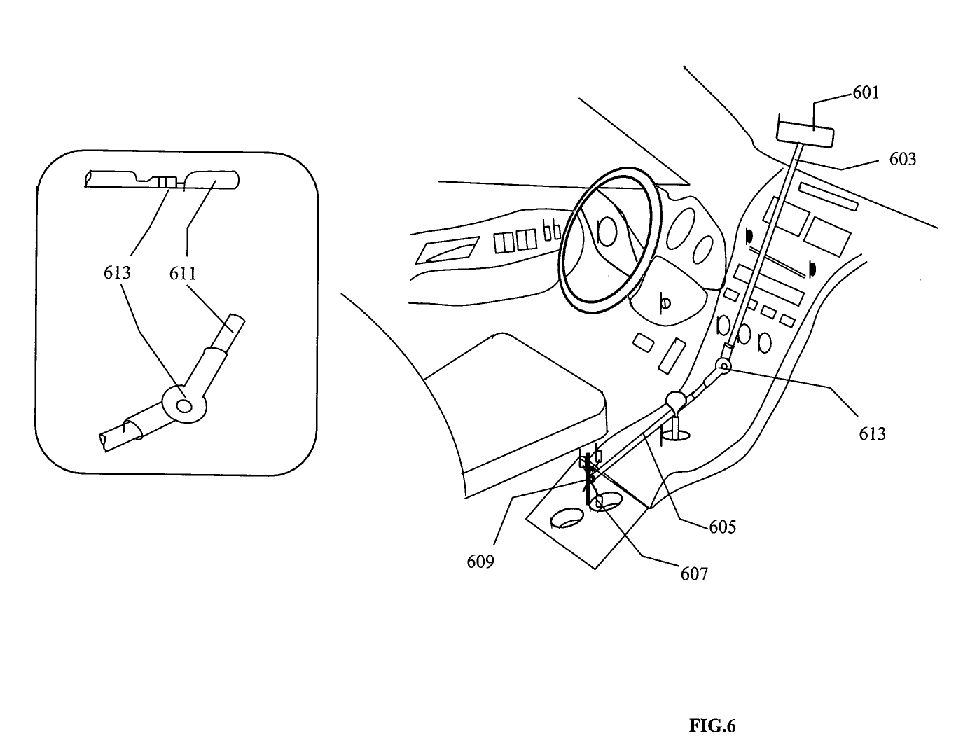

FIG. 6 is an illustration of a smartphone two link extender arm and dashboard cam with driver console anchor in accordance with an embodiment of the invention. A two link arm 603 605 supporting a mobile case for a smartphone in an embodiment of the invention is shown with a joint coupling 613 a first 603 and second arm 605 links to form an articulated linkage. Other embodiments can have ball-and-socket and other rotational style joints, which provide a manual joint friction holding positioning adjustment set position. Each of the first 603 and second telescoping arm 605 segments have a first and second ends. The first end of the first arm segment 605 has a base anchor 609 in the form of a spring clamp 607. The second end of the first segment 605 has a hinge joint which manual adjustably couples the second end of the first arm to the first end of the second arm 603 and provides an easily adjustable rotational degree of freedom between the two arm segments 603 605.

In an embodiment of the invention a mid-joint 613 includes the following: first 605 and second 603 segment mating wheel like coupling 613 having detents, with round flat surfaces joined at their center 613 of flat round plate like structures and mounted on the second end of the first arm and the first end of the second arm, respectively. Round flat surfaces maintain a settable detent station and rotatable mating relation, and also guide 611 for an arm extension that maintains an easily manually set position. Friction instead of detents can be used as well for continuous stationary setting.

The mid joint 613 provides a settable rotating as the angle between the two arms links. This rotation maintains a frictional and detent tension arm position. The settable station arm angle counterbalances the varying gravitational forces on the first and second arms from the changes in the angle between the arms.

In an embodiment of the invention of an extensible and collapsible arm accessory for a smartphone further comprising a two linkage arm, the two tube links have an electrical flexible coil cord accommodating the extension and collapse of the arm. The two links have substantially the same or similar material of hollow tube like links connected by a rotatable and repositioning joint.

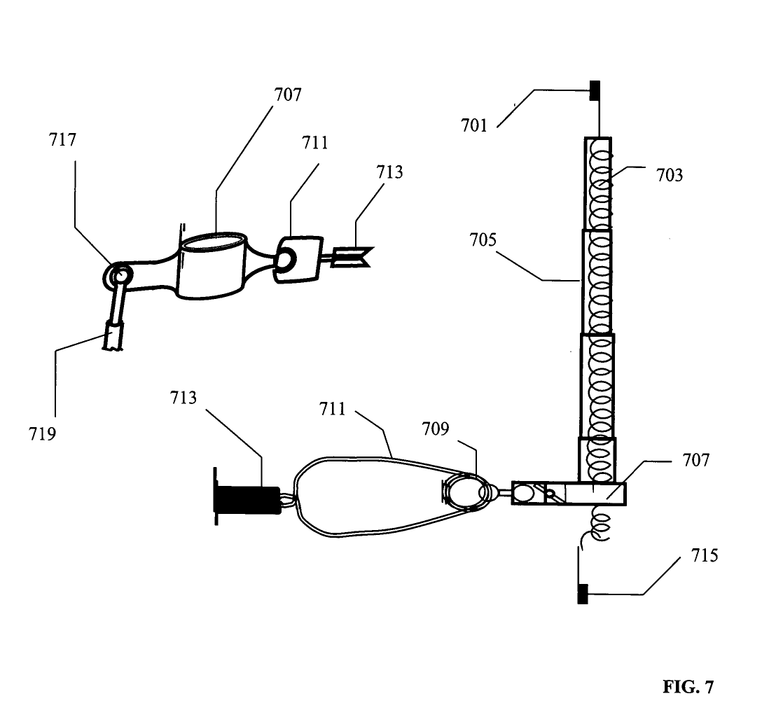

FIG. 7 is an illustration of a smartphone telescoping extender arm and dashboard cam with tube arm 705 internal flexible coil electrical cord 703 in accordance with an embodiment of the invention. The two cord ends contain 701 715 electrical connectors compatible with the market smartphone design formats and protocols, for example a USB connector to an automobile cigarette lighter socket connector.

In an embodiment of the invention the arm tube 705 interior has a coiled electrical cord 703 assembly for re-charging the smartphone and more while docked. The many smartphone apps are then disposed to function comfortably with minimum additional driver manual positioning adjustment. For example the video cam once positioned will function automatically without manual intervention, as would the GPS. Any voice control can be used when the smartphone is positioned proximate to the user. The smartphone external lighting can be used hands free for an “overhead’ or reading light by first positioning the smartphone over the object to map illumination light, or independently from the interior lighting as a hands free flashlight.

A dual anchor implementation for both a rear view mirror stem and interior lip structure is illustrated in FIG. 7. In an embodiment of the invention the anchor attachment serves dual purpose, a pipe style collar clamp 707 for a rear view mirror stem attachment and a console spring clamp 711 713 for stationing the arm to a secure position in the cockpit.

In an embodiment the arm accessory anchor serves alternate sources of anchoring. The rear view mirror stem provides a reliable anchor when fitted by the pipe clamp collar 707 but the arm can also be held firmly by the spring clamp 713 pincher 713 or other clamp attached to the pipe clamp collar 707 opposite the arm joint 717 for anchoring the arm 719.

In the extensible and collapsible arm accessory two linkage arm embodiment, the telescoping tube arm provide an electrical coil cord 703 having two ends 701 715 for accommodating the extension and collapse of the extensible-collapsible arm 705 while maintaining electrical connectivity.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. An automobile smartphone extender arm and dashboard-cam accessory further comprising:
an anchoring component at one end and a universal smartphone holder at the distal end,

1. An extensible and collapsible arm and dashboard-cam accessory for a smartphone further comprising:
a boon extensible and collapsible arm having an anchoring component at one end and a universal smartphone holder at the distal end;
the anchoring component having a pipe clamp style coupling to a rearview mirror windshield stem and a rotatable joint coupler having a radial sawtooth surface detent mating with the collapsible arm anchor component end;
a anchoring clamp neck having an coupled spring clamp;
an attachable smartphone holder rotatably coupled to the arm distal end;
an electrical cord, wherein the case further comprises a means to manually control the flow of electric power to the smartphone device and said electric power flow control means to permit manual access to said electric power flow control, and
movable rotatable joints between the arm distal end and attachable case
whereby a user can quickly and easily adjust the position of the smartphone removably attached to the case.

2. An extensible and collapsible arm accessory for a smartphone as in claim 1 further comprising a holder hardcase rotatably coupled to the arm at the distal end.

3. An extensible and collapsible arm accessory for a smartphone as in claim 1 further comprising arm composition of materials consisting essentially of plastic, carbon composite, metal, and clear plastic.

4. An extensible and collapsible arm accessory for a smartphone as in claim 1 further comprising a two linkage arm, the two tube links having an electrical flexible coil cord accommodating the extension and collapse of the arm.

5. An extensible and collapsible arm accessory for a smartphone as in claim 1 further comprising a two linkage arm, the two links substantially of the similar material and hollow tube like coupled by a rotatable joint.

6. An extensible and collapsible arm accessory for a smartphone as in claim 5 further comprising a two linkage arm, the two tube links having an electrical coil cord accommodating the extension and collapse of the arm.

7. An extensible and collapsible arm accessory for a smartphone as in claim 1 further comprising a universal vacuum holder.

8. An extensible and collapsible arm accessory for a smartphone as in claim 1 further comprising a rotatable ball-and-socket holder component coupled to the arm distal end.

9. An extensible and collapsible arm accessory for a smartphone as in claim 1 further comprising a dual anchor construction for both a rear view mirror stem and interior lip structure.

10. A method for an extensible and collapsible arm and dashboard-cam accessory for a smartphone further comprising the steps of:
providing a boon extensible and collapsible arm having two ends with an anchoring component having a pipe clamp style coupling to a rearview mirror windshield stem and a rotatable joint coupler having a radial sawtooth surface detent mating with the collapsible arm anchor component end;
having the anchoring component with a pipe clamp style collar coupling to a rearview mirror windshield stem;
connecting the anchoring clamp neck with an integrated spring clamp;
coupling an attachable smartphone holder rotatably to the arm distal end;
providing an electrical cord, wherein the smartphone holder further comprises a means to manually control the flow of electric power to the smartphone device and said electric power flow control means to permit manual access to said electric power flow control, and
providing rotatable joints between the arm distal end and attachable case
whereby a user can quickly and easily adjust the position of the smartphone removably attached to the case.

11. A method for an extensible and collapsible arm accessory for a smartphone as in claim 10 wherein a holder hardcase is rotatably connected to the arm at the distal end with a ball-and-socket coupler.

12. A method for an extensible and collapsible arm accessory for a smartphone as in claim 10 wherein the composition of materials consisting essentially of plastic, carbon composite, metal, and clear plastic.

13. A method for an extensible and collapsible arm accessory for a smartphone as in claim 10 further comprising the steps of linking two tube links having an electrical flexible coil cord accommodating the extension and collapse of the arm.

14. A method for an extensible and collapsible arm accessory for a smartphone as in claim 10 wherein linkage arm links are substantially the similar material and hollow tube like coupled by a rotatable joint.

15. A method for an extensible and collapsible arm accessory for a smartphone as in claim 13 wherein the two linkage arm, the two tube links having an electrical coil cord accommodating the extension and collapse of the arm.

16. A method for an extensible and collapsible arm accessory for a smartphone as in claim 10 further comprising the steps of constructing a universal vacuum holder on the arm distal end for smartphone coupling.

17. A method for an extensible and collapsible arm accessory for a smartphone as in claim 10 further comprising the steps of connecting a rotatable ball-and-socket holder component coupled with the arm distal end.

18. A method for an extensible and collapsible arm accessory for a smartphone as in claim 10 further comprising the steps of a dual anchor construction for both a rear view mirror stem and interior lip structure.
